(19) United States
(12) Patent Application Publication
(10) Pub. No.: US 2024/0032164 A1
(43) Pub. Date: Jan. 25, 2024

(54) Lighting Control Systems

(71) Applicant: Jeffrey Glen Benson, Knoxville, TN (US)

(72) Inventor: Jeffrey Glen Benson, Knoxville, TN (US)

(21) Appl. No.: 17/872,767

(22) Filed: Jul. 25, 2022

(51) Int. Cl. H05B 45/20; H05B 47/19

(52) U.S. Cl. CPC H05B 45/20; H05B 47/19

(57) ABSTRACT

A lighting control system powered by a power source having: a transmitter, a receiver, and a circuit; wherein the transmitter and the receiver are powered by the power source (independently or together). The transmitter is in communication with the receiver to control the LED lighting; the LED lighting having addressable diodes, such that the LED lighting is able to be affected within the circuit as to color selection in a live programming mode via signals sent and received.

### BACKGROUND OF THE INVENTION

The following includes information that may be useful in understanding the present invention(s). It is not an admission that any of the information provided herein is prior art, or material, to the presently described or claimed inventions, or that any publication or document that is specifically or implicitly referenced is prior art.

### 1. FIELD OF THE INVENTION

The present invention relates generally to the field of lighting and more specifically relates to lighting control.

### 2. DESCRIPTION OF THE RELATED ART

Many individuals enjoy celebrating holidays and special occasions. Individuals may host fun events to participate in, cook and serve specialty seasonal foods, and decorate for these occasions. One example is for Christmas people may serve turkey and decorate a tree or their home with festive lighting. Lighting may also be used to illuminate pathways for walking during low lights conditions. It is desirable that the lighting be effective for its intended purpose, easy to use, easy to manipulate, and safe in design.

Various attempts have been made to solve the above-mentioned problems such as those found in U.S. Pat. Nos. 6,441,558; 7,221,110; 7,489,089; 7,821,212; 8,742,694; 9,313,842; and 9,622,329. This art is representative of lighting. None of the above inventions and patents, taken either singly or in combination, is seen to describe the invention as claimed.

Ideally, a lighting control system should provide performance and functional beauty and yet would operate reliably and be manufactured at a modest expense. Thus, a need exists for a reliable lighting control system to avoid the above-mentioned problems.

### BRIEF SUMMARY OF THE INVENTION

In view of the foregoing disadvantages inherent in the known lighting art, the present invention provides a novel lighting control system. The general purpose of the present invention, which will be described subsequently in greater detail is to provide a novel effective and efficient lighting control means.

A lighting control system powered by at least one power source is disclosed herein comprising: a transmitter, a receiver, and a circuit; wherein the transmitter and the receiver are powered by the at least one power source (independently or together). The transmitter is in communication with the receiver to control the LED lighting; the LED lighting having addressable diodes, such that the LED lighting is able to be affected within the circuit as to color selection in a live programming mode via signals sent and received.

In the preferred embodiment of the lighting control system (powered by at least one power source), the system comprises: a transmitter, a receiver, and a has at least one circuit (wired or wireless), wherein the transmitter and the receiver are powered by the at least one power source (the transmitter and the receiver may share a power source or be independently powered). The transmitter is in communication with the receiver to control the LED lighting. The LED lighting has multiple addressable diodes, such that the LED lighting is able to be affected within the circuit as to color selection, hue, etc. in a live programming mode via signals sent and received. The transmitter comprises a processor capable of running a software application to effect transmissions and communicates with the receiver delivering an output as to the desired illumination of the user.

A method of controlling a lighting control system is also disclosed herein comprising the steps of: 1) providing a lighting control system comprising: a transmitter, a receiver, and a circuit; wherein the transmitter and the receiver are powered by at least one power source (preferably independently). The transmitter is in communication with the receiver to control the LED lighting; the LED lighting having addressable diodes, the LED lighting being in a string orientation in a consecutive order, such that the LED lighting is able to be affected within the circuit as to color selection, separation, and hue in a live programming mode via at least one signal sent and received, and 2) generating the at least one signal via a user manipulating the transmitter comprising a processor capable of running a software application to affect transmissions which communicates with the receiver delivering an effected output as to user-preferred, selectable illumination of the LED lighting. The method allows that the live programming mode is able to be used in real-time according to a user-determined preference and the color selection is not pre-programmed in preferred embodiments.

The present invention holds significant improvements and serves as a lighting control system. For purposes of summarizing the invention, certain aspects, advantages, and novel features of the invention have been described herein. It is to be understood that not necessarily all such advantages may be achieved in accordance with any one particular embodiment of the invention. Thus, the invention may be embodied or carried out in a manner that achieves or optimizes one advantage or group of advantages as taught herein without necessarily achieving other advantages as may be taught or suggested herein. The features of the invention which are believed to be novel are particularly pointed out and distinctly claimed in the concluding portion of the specification. These and other features, aspects, and advantages of the present invention will become better understood with reference to the following drawings and detailed description.

### BRIEF DESCRIPTION OF THE DRAWINGS

The figures which accompany the written portion of this specification illustrate embodiments and method(s) of use for the present invention, lighting control system, constructed and operative according to the teachings of the present invention.

FIG. 1 shows a perspective view illustrating a lighting control system according to an embodiment of the present invention.

FIG. 2 is a perspective view illustrating the lighting control system as used to display various color selections according to an embodiment of the present invention of FIG. 1.

FIG. 3 is a perspective view illustrating the lighting control system being used to illuminate the LED lighting in a single color and alternately in color groups according to an embodiment of the present invention of FIG. 1.

FIG. 4 is a perspective view illustrating alternate transmitter(s) (remote control and a phone) for use with the lighting control system according to an embodiment of the present invention of FIG. 1.

FIG. 5 is a flowchart illustrating a method of use for the lighting control system according to an embodiment of the present invention of FIGS. 1-4.

The various embodiments of the present invention will hereinafter be described in conjunction with the appended drawings, wherein like designations denote like elements.

### DETAILED DESCRIPTION

As discussed above, embodiments of the present invention relate to lighting and more particularly to a lighting control means as used to improve the useful functionality and decoration of illumination via user control.

Generally speaking, The LED light controller system (lighting control system) comprises a remote transmitter, a controller receiver, and specific programming features that make the system unique for use with LED lighting products. The system can be controlled via suitable means such as a smartphone application or remote transmitter or the like.

The system is configured to work with virtually any rope light, string light, strip light, and virtually any other type of LED lighting product using addressable diodes. For purposes of the present invention according to this disclosure a string of lights comprises any type of LED lights in a consecutive order which is unlimited in the length and the number of the string of lights or diodes. A light within the system is a light emitting diode (LED) which is addressable. The present system will function with any suitable voltage or amperage.

The LED lighting referred to herein is in a string orientation in a consecutive order, such as those found in holiday string lighting, lighting used in night clubs, track lighting and the like. The color selection enables variations in hue of the LED lighting via the addressable diodes, wherein the color selection comprises at least one color separation mode. The color selection comprises a clear mode as a reset means (start-over) which can be performed in real time ‘live’. The color selection is not pre-programmed in preferred embodiments. The color separation mode is able to control an individual color of the LED lighting and alternately an individual color-group of the LED lighting. The transmitter and the receiver are able to be in communication remotely. The LED lighting has the capability of illumination as white-illumination and non-white-illumination (colored) through an entire spectrum of colors making it a desirable illumination means across a variety of applications and events.

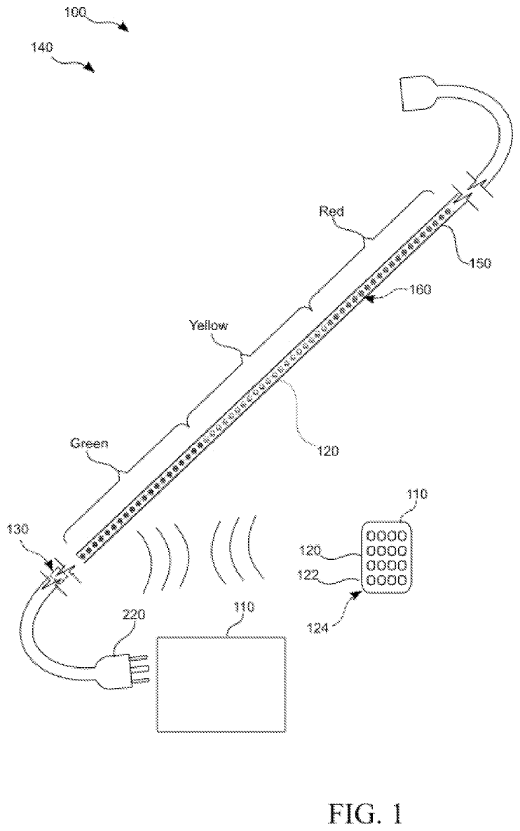

Referring to the drawings by numerals of reference there is shown in FIGS. 1-4, a lighting control system 100 powered by at least one power source 110 comprising: a transmitter 120, a receiver 130, and a circuit 140; wherein the transmitter 120 and the receiver 130 are powered by the at least one power source 110 (independently or together). The transmitter 120 is in communication with the receiver 130 to control LED lighting 150; the LED lighting 150 having addressable diodes 160, such that the LED lighting 150 is able to be affected within the circuit 140 as to color selection in a live programming mode via signals sent and received. Live programming mode is available for use and the remote can be preprogrammed as well. Those with ordinary skill in the art will now appreciate that upon reading this specification and by their understanding the art of sending and receiving signals across a circuit 140 as described herein, methods of communication will be understood by those knowledgeable in such art. Circuitry as referred to herein includes all wiring and communication means necessary for communication of signals induced by the user and suitable equivalents may be used.

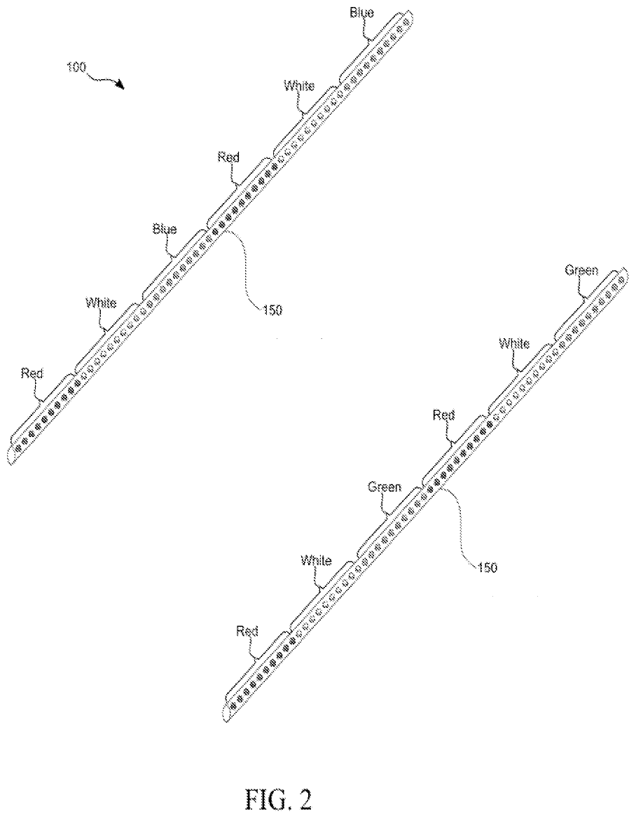

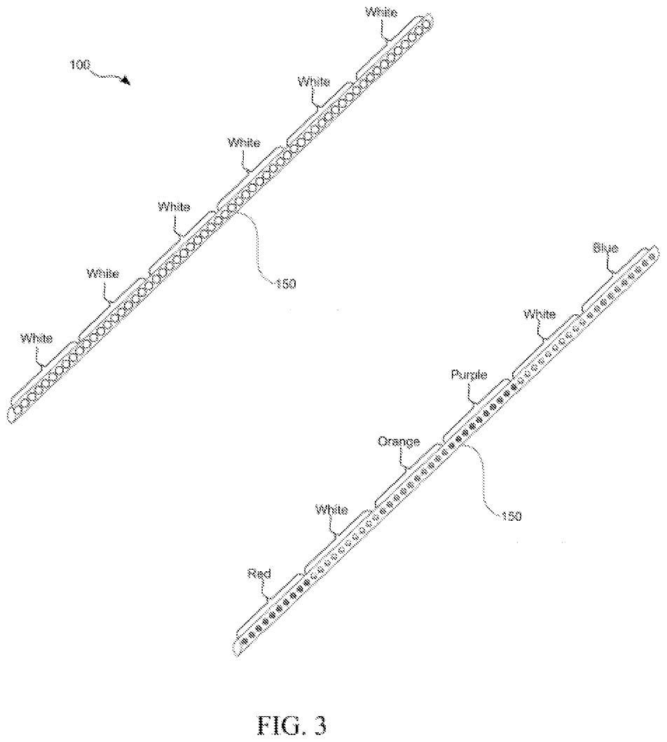

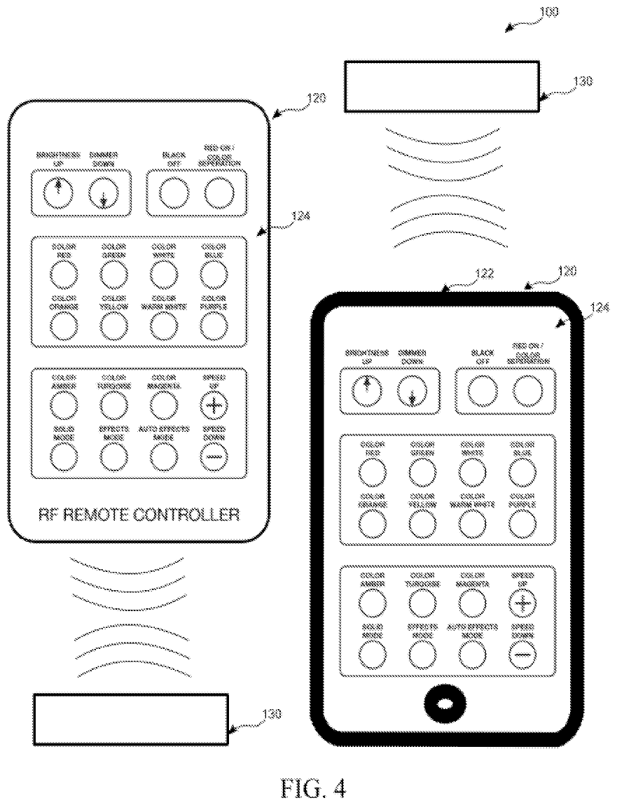

In certain embodiments the transmitter 120 comprises a cellular phone 122. The cellular phone 122 (such as a smartphone), as shown in FIG. 4, comprises a processor 124 capable of running a software application (app) to effect transmissions and communicates with the receiver 130 delivering an output as to desired illumination (examples of desired illumination shown in FIGS. 2-3. The user is able to manipulate the app via touching the screen, manipulating buttons or via suitably equivalent means. The functionality of the lighting control system 100 begins with the remote that sends an RF (Radio Frequency) or IR (Infrared signal) or other to the controller. The controller receives that signal from a remote button and then sends that signal to the addressable diode 160. That signal may be an effect or it may be a color selection. The remote is a transmitter 120 so may be a phone app or any other type of remote transmitter, as shown in FIGS. 1 and 4. In alternate embodiments the transmitter 120 does not comprise a cellular phone (both versions shown in FIG. 4.

The LED lighting 150 referred to herein is in a string orientation in a consecutive order such as for example rope lights or the like, as previously mentioned. The color selection enables variations in hue of the LED lighting 150 via the addressable diodes 160. The color selection of the lighting control system 100 comprises at least one color separation mode; wherein the color selection comprises a clear mode as a reset means. In this way the user can manipulate the LED lighting 150 to stop the current illumination and begin again with a user-preferred illumination, and another and so on.

The clear mode used in the present invention allows the live programming mode to function the way it does. It can also function with a phone app in much the same way. As an example, the remote button #15 may clear the colors selected and allows the user to start over in choosing a new color group display. Then remote button #16 may clear the effect selected and start over with a new effect display. The clear mode also functions with the color selection mode in that if the user wishes to have only 1 color on the entire string of lights (as illuminated in white shown in FIG. 3). The user can choose red for instance for the entire length of the string of lights. If they wish to change to green they press the clear button and press the green button for the entire length of the string of lights of LED lighting 150. This feature allows the user to clear any color or colors and any effect and start over to create exactly what is desired. This allows the customer or user to become the ‘programmer’ and create anything they wish instead of being limited to a preprogrammed light display.

The color selection in preferred embodiments is not pre-programmed. In other embodiments of the lighting control system 100 the color selection is pre-programmed yet able to be manipulated in real-time according to a user-determined preference. The color separation mode is able to control an individual color of the LED lighting 150 and alternately the color separation mode is able to control an individual color-group of the LED lighting 150. Remote numbers may be any number on the remote control depending on the size of the remote and how many functionalities it can process. The lighting control system 100 can also function with a phone app in much the same way to manipulate the color selection mode, as shown in FIG. 1. The color separation mode mentioned herein functions in a sophisticated way since it involves separating individual colors into larger color groups.

Pre-programmed mode: the color selection mode can be preprogrammed, referring to the programming code written can be processed by a single one button on the remote and the colors on the LED string of lights could be Red, White, and Blue. With all 3 colors displayed on the string of lights (LED lighting 150) at the same time repeated over and over to the end of the string of lights. The display can be any color combination of as many colors as possible. By way of illustration, if the remote button code is 3 and equating to red, white, and blue, variation shown in FIG. 2, by pressing that single button the string of lights (LED lighting 150) will display those specific colors at the same time on the string of lights in a repeating scheme for the entire length of the string of lights. This is also called ‘color grouping’ for choosing the colors the user wishes to be displayed. This feature also function the same way with effects.

Referring now to color separation mode, remote numbers may do virtually anything within the present invention depending on the size of the remote and how many functionalities it can process. It can also function with a phone app in much the same way. The unique features made available for use by the present invention are made possible by the programming code in the controller. The remote is a static number which means it is always that number and that number is associated with the programming code in the controller then sent to the diode.

Once the user has chosen their color group such as 1Red-1Green-1White they are able to take those individual colors and form a larger color group. This creates a style and a specific look to the string of lights; LED lighting 150. There is a color separation button and as an example it could be the #10 button on the remote transmitter. When the user presses that button once, the colors expand by 1 color, meaning the light now has 2 Red-2 Green-2 White repeating. When the user presses it again once now displayed is 3 Red-3 Green-3 White. The user can press that button as many times as they wish and can display 20 Red-20 Green-20 White. This is a virtually unlimited functionality. For example, if you had 20 of each color you could press the button #11 and it would shrink the number by 1 each time you press it until you are back to 1 of each color. In this way for example a user can use the LED lighting 150 to be red along exactly one length of the wall of a room, green along the next, blue on the next, and orange on the last wall. Different variations for display are shown in FIGS. 2 and 3.

The user may also wish to have an odd number of each color such as 20 Red-10 Green-5 White. In order to do this, as an example, press the red color button #1 and the color red increases by 1 each time that specific button is pressed. If it is pressed 20 times there will be 20 Red. It is the same process for the color green or the color white. In this way the user can create any specific variation they desire.

Referring now to the color separation mode functioning with an individual color as opposed to controlling a color group. The color separation mode makes it possible to live program millions of combinations as to the colors and effects and create the most beautiful light displays. It can also be preprogrammed in any numerical order.

Live programming mode: this is a novel feature of the programming code making it a ‘live’ programming feature. As an example, if the color red is associated with the remote button code #1 and that signal is sent to the controller it would cause to display the color red on the entire length of the string of lights (LED lighting 150). Then if the user wishes to display the color green as an example the color green button on the remote could be #2. The user presses the green button #2 and the green color is displayed on the string of lights (LED lighting 150) along with the color red at the same time on the string of lights. At this point the red and green colors are displayed at the same time without preprogramming anything. It is done ‘live’ as the user presses those buttons. Further, for example, if the user chooses white it may be added the same way. Displayed now are 3 colors (Red-Green-White) displayed on the string of lights as each button is pressed. This discloses and enables the unique functionality of the live programming code in the color selection mode. The user may wish to add many other colors which are effectively unlimited in their hue and the number of colors the user may wish to add. This is also called color grouping as choosing the colors the user wishes to be displayed. This would function the same way with effects. The number of colors is virtually unlimited.

The transmitter 120 and the receiver 130 are able to be in communication remotely. The LED lighting 150 when enabled with the present system 100 has the capability of illumination as white-illumination and illumination as non-white-illumination such as red, green, yellow, blue and the full or partial spectrum of visible colors. The non-white-illumination referred to herein includes an entire spectrum of colors; wherein the entire spectrum of colors can be hue-manipulated.

Another function of the color selection mode is choosing the hue of the lights in the display of the LED lighting 150. For example, if 3 hue settings are used for the color selection mode, 1 is “Standard” which is the normal hue setting for all the colors, 2 is “Pastel’ which changes the hue of each color to a softer pastel look, and 3 is “Tropical” which is a brighter look for parties and such. The lights of LED lighting 150 function the same way regardless which color hue is used.

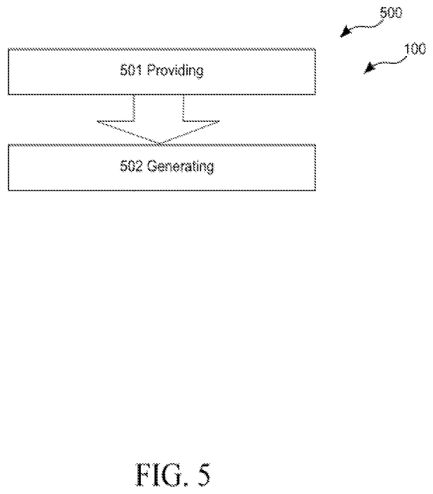

Referring now to FIG. 5, showing a method of controlling 500 a lighting control system 100 comprising the steps of: step one 501 providing a lighting control system 100 comprising: a transmitter 120, a receiver 130, and a circuit 140; wherein the transmitter 120 and the receiver 130 are powered by at least one power source 110 (preferably independently). The transmitter 120 is in communication with the receiver 130 to control LED lighting 150; the LED lighting 150 having addressable diodes 160, the LED lighting 150 being in a string orientation in a consecutive order, such that the LED lighting 150 is able to be affected within the circuit 140 as to color selection, separation, and hue in a live programming mode via at least one signal sent and received, and step two 502 generating the at least one signal via a user manipulating the transmitter 120 comprising a processor 124 capable of running a software application to affect transmissions which communicates with the receiver 130 delivering an effected output as to user-preferred, selectable illumination of the LED lighting 150. The method 500 allows that the live programming mode is able to be used in real-time according to a user-determined preference. The color selection is not pre-programmed in preferred embodiments. The tangible result is visible lighting affect that is user-selectable in real-time.

It should be noted that the steps described in the method of use can be carried out in many different orders according to user preference. The use of “step of” should not be interpreted as “step for”, in the claims herein and is not intended to invoke the provisions of 35 U.S.C. § 112, ¶6. Upon reading this specification, it should be appreciated that, under appropriate circumstances, considering such issues as design preference, user preferences, marketing preferences, cost, structural requirements, available materials, technological advances, etc., other methods of use arrangements such as, for example, different orders within above-mentioned list, elimination or addition of certain steps, including or excluding certain maintenance steps, etc., may be sufficient.

The embodiments of the invention described herein are exemplary and numerous modifications, variations and rearrangements can be readily envisioned to achieve substantially equivalent results, all of which are intended to be embraced within the spirit and scope of the invention. Further, the purpose of the foregoing abstract is to enable the U.S. Patent and Trademark Office and the public generally, and especially the scientist, engineers and practitioners in the art who are not familiar with patent or legal terms or phraseology, to determine quickly from a cursory inspection the nature and essence of the technical disclosure of the application.

What is claimed is new and desired to be protected by Letters Patent is set forth in the appended claims:

1. A lighting control system powered by at least one power source comprising:
a transmitter,
a receiver, and
a circuit,
wherein said transmitter and said receiver are powered by said at least one power source, and
wherein said transmitter is in communication with said receiver to control LED lighting, said LED lighting having addressable diodes, such that said LED lighting is able to be affected within said circuit as to color selection in a live programming mode via signals sent and received.

2. The lighting control system of claim 1 wherein said transmitter comprises a cellular phone, said cellular phone comprises a processor capable of running a software application to effect transmissions and communicates with said receiver delivering an output as to desired illumination.

3. The lighting control system of claim 1 wherein said LED lighting is in a string orientation in a consecutive order.

4. The lighting control system of claim 1 wherein said color selection enables variations in hue of said LED lighting via said addressable diodes.

5. The lighting control system of claim 1 wherein said color selection comprises at least one color separation mode.

6. The lighting control system of claim 1 wherein said color selection comprises a clear mode as a reset means.

7. The lighting control system of claim 6 wherein said color selection is not pre-programmed.

8. The lighting control system of claim 1 wherein said color selection is pre-programmed yet able to be manipulated in real-time according to a user-determined preference.

9. The lighting control system of claim 5 wherein said color separation mode is able to control an individual said color of said LED lighting.

10. The lighting control system of claim 5 wherein said color separation mode is able to control an individual color-group of said LED lighting.

11. The lighting control system of claim 1 wherein said transmitter does not comprise a cellular phone.

12. The lighting control system of claim 1 wherein said wherein said transmitter and said receiver are able to be in communication remotely.

13. The lighting control system of claim 1 wherein said LED lighting has capability of illumination as white-illumination.

14. The lighting control system of claim 1 wherein said LED lighting has capability of illumination as non-white-illumination.

15. The lighting control system of claim 14 wherein said non-white-illumination includes an entire spectrum of colors.

16. The lighting control system of claim 15 wherein said entire spectrum of colors can be hue-manipulated.

17. A lighting control system powered by at least one power source comprising:
a transmitter,
a receiver, and
a circuit,
wherein said transmitter and said receiver are powered by said at least one power source, and
wherein said transmitter is in communication with said receiver to control LED lighting, said LED lighting having addressable diodes, such that said LED lighting is able to be affected within said circuit as to color selection in a live programming mode via signals sent and received,
wherein said transmitter comprises a processor capable of running a software application to effect transmissions and communicates with said receiver delivering an output as to desired illumination,
wherein said LED lighting is in a string orientation in a consecutive order,
wherein said color selection enables variations in hue of said LED lighting via said addressable diodes,
wherein said color selection comprises at least one color separation mode,
wherein said color selection comprises a clear mode as a reset means,
wherein said color selection is not pre-programmed,
wherein said color separation mode is able to control an individual said color of said LED lighting and alternately an individual color-group of said LED lighting,
wherein said transmitter and said receiver are able to be in communication remotely, and
wherein said LED lighting has capability of illumination as white-illumination and non-white-illumination through an entire spectrum of colors.

18. A method of controlling a lighting control system comprising the steps of:
providing a lighting control system comprising:
a transmitter,
a receiver, and
a circuit,
wherein said transmitter and said receiver are powered by at least one power source independently, and
wherein said transmitter is in communication with said receiver to control LED lighting, said LED lighting having addressable diodes, said LED lighting is in a string orientation in a consecutive order, such that said LED lighting is able to be affected within said circuit as to color selection, separation, and hue in a live programming mode via at least one signal sent and received, and
generating said at least one signal via a user manipulating said transmitter comprising a processor capable of running a software application to affect transmissions which communicates with said receiver delivering an effected output as to user-preferred, selectable illumination of said LED lighting.

19. The method of claim 18 wherein said live programming mode is able to be used in real-time according to a user-determined preference.

20. The method of claim 19 wherein said color selection is not pre-programmed.
